(19) United States
(12) Patent Application Publication
(10) Pub. No.: US 2019/0064450 A1
(43) Pub. Date: Feb. 28, 2019

(54) METHODS OF FORMING GLASS-BASED FERRULES AND GLASS-BASED COUPLING APPARATUS

(71) Applicant: CORNING OPTICAL COMMUNICATIONS LLC, Hickory, NC (US)

(72) Inventor: Alan Frank Evans, Beaver Dams, NY (US)

(21) Appl. No.: 16/170,199

(22) Filed: Oct. 25, 2018

Related U.S. Application Data
(63) Continuation of application No. PCT/US17/29584, filed on Apr. 26, 2017.
(60) Provisional application No. 62/329,435, filed on Apr. 29, 2016.
(60) Provisional application No. 62/329,566, filed on Apr. 29, 2016.

(51) Int. Cl. G02B 6/38; G02B 6/42; G02B 6/30; C03B 23/047

(52) U.S. Cl. CPC G02B 6/3854; G02B 6/4236; G02B 6/3839; C03B 23/047; G02B 6/3885; G02B 6/30; G02B 6/3869

(57) ABSTRACT

Methods of forming glass-based ferrules and glass-based coupling apparatus for use in forming optical interface devices for photonic systems are disclosed and include forming glass or polymer alignment members that each includes an alignment feature. Methods of forming the alignment members are also disclosed, and include glass drawing and molding processes. The alignment members can be attached in a spaced apart configuration to the surface of a glass support substrate to form a ferrule. The alignment members can also be attached to the surface of a photonic integrated circuit to form a coupling apparatus. The alignment members can be made in a way that allows for same alignment members to be used to form either the ferrules or the coupling apparatus.

### CROSS-REFERENCE TO RELATED APPLICATIONS

This application is a continuation of International Application No. PCT/US17/29584, filed on Apr. 26, 2017, which claims the benefit of priority to U.S. Application Nos. 62/329,435 and 62/329,566, both filed on Apr. 29, 2016, the content of which is relied upon and incorporated herein by reference in entirety.

### FIELD

The present disclosure relates to integrated photonics, and in particular relates to methods of forming glass-based ferrules and glass-based coupling apparatus.

### BACKGROUND

Photonic systems are presently used in a variety of applications and devices to communicate information using light (optical) signals. Photonic systems may include photonic integrated circuits (PICs), which are analogous to electronic integrated circuits in that they integrate multiple components into a single material where those components operate using light only or a combination of light and electricity. A typical PIC has a combination of electrical and optical functionality, and can include light transmitters (light sources) and light receivers (photodetectors), as well as electrical wiring and like components that serve to generate and carry electrical signals for conversion to optical signals and vice versa.

A PIC includes one or more optical waveguides that carry light in analogy to the way metal wires carry electricity in electronic integrated circuits. Just as the electricity traveling in the wires of an electronic integrated circuit carries electrical signals, the light traveling in the waveguides of a PIC carries optical signals.

To transmit the optical signals from the PIC to a remote device, the optical signals carried by a waveguide in the PIC need to be transferred or “optically coupled” to a corresponding optical fiber connected to the remote device. This optical coupling should have a suitable optical efficiency and the optical coupling apparatus should have a compact footprint, as well as being low-cost and able to be reliably connected and disconnected. In addition, the optical coupling should optically efficient even at relatively high operating temperatures since the PICs may generate significant amounts of heat. These relatively high operating temperatures may result in thermal expansion due to differences in the coefficients of thermal expansion (CTE) of the various components of the optical interface device and can adversely impact the optical coupling efficiency.

### SUMMARY

An aspect of the disclosure is a method of forming a ferrule or a coupling apparatus. The method includes: drawing a glass preform to form a drawn glass preform section with a size reduction, wherein the glass preform has a first longitudinal alignment feature; dividing the drawn glass preform section into at least first and second alignment members, with each alignment member having a length L that is in the range from 2 mm to 12 mm; and attaching the first and second alignment members in a spaced apart configuration to an upper surface of either: i) a glass support substrate to form the ferrule or ii) a PIC to form the coupling apparatus.

Another aspect of the disclosure includes a method of forming glass-based ferrules for a ferrule assembly. The method includes: drawing a glass preform to form a drawn glass preform section with a size reduction, wherein the glass preform has a first longitudinal alignment feature, and wherein the drawn pre-form section has a second longitudinal alignment feature defined by the first longitudinal alignment feature; dividing the drawn glass preform section into a plurality of canes; securing the plurality of canes on an upper surface of a glass support sheet to define a fabrication structure, wherein the canes are arranged in spaced-apart pairs; and dicing the fabrication structure including the plurality of canes and the glass support sheet to form a plurality of the ferrules, with each ferrule having a pair of spaced apart glass alignment members defined by the diced canes and supported by a glass support substrate defined by the diced glass support sheet.

Another aspect of the disclosure includes a method of forming an alignment member for a ferrule or a coupling apparatus. The method includes: forming a monolithic body with a central body axis, a length and a longitudinal central aperture in the form of a cross defined by first and second orthogonal sections having respective first and second central axes orthogonal to and that intersect at the central body axis, wherein the first and second orthogonal sections define four quadrants of the monolithic body, with each quadrant including a longitudinal bore that runs down the length of the monolithic body and offset from the central body axis; separating the monolithic body into the four quadrants, with each quadrant defining an alignment sub-structure; and cross-sectionally cutting at least one of the alignment sub-structures to form at least one alignment member.

Another aspect of the disclosure is a method of forming an alignment member that is “dual use,” i.e., that can be used for both a ferrule assembly that has a glass support substrate that supports optical fibers and a coupling apparatus for a PIC assembly that has a PIC that supports optical waveguides. The method includes: drawing a glass preform to form a drawn glass preform section with a size reduction, wherein the glass preform has a longitudinal alignment feature and a rectangular cross-sectional shape with first and second adjacent sides; dividing the drawn glass preform section into a plurality of alignment members, with each alignment member having a length L that is in the range from 2 mm to 12 mm; and wherein the optical waveguides and optical fibers define a relative alignment offset Δz, and wherein the longitudinal alignment feature resides at a first distance H1 from the first side and a second distance H2 from the second side, and wherein H1>H2 and wherein Δz is substantially equal to H1−H2.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the Detailed Description serve to explain principles and operation of the various embodiments. As such, the disclosure will become more fully understood from the following Detailed Description, taken in conjunction with the accompanying Figures, in which:

FIG. 1 is an elevated view of an example photonic system in an unmated state that includes an integrated photonic assembly that has a PIC assembly that includes a coupling apparatus configured to be operably coupled with a ferrule assembly, wherein the PIC assembly and ferrule assembly define an optical interface device;

FIG. 2A is a close-up, front-on view of an example PIC assembly of the integrated photonic assembly of FIG. 1, wherein the PIC assembly includes a coupling apparatus defined by spaced apart alignment members;

FIG. 2B is a front elevated view of an example alignment member of the coupling apparatus of FIG. 2A and that can also be used to form a ferrule of the ferrule assembly;

FIG. 3A is a back-side elevated view of an example ferrule assembly according to the disclosure;

FIG. 3B is a front-on assembled view of the ferrule assembly of FIG. 3B, which uses the same or similar types of alignment members as the coupling apparatus;

FIG. 4 is a cross-sectional view of a drawing system used in an the process of fabricating the alignment members used to form ferrules and coupling sub-assemblies;

FIG. 5A is a front-elevated view of an example side-by-side arrangement of canes formed by dividing up a drawn pre-form section formed using the drawing system of FIG. 4;

FIG. 5B is a top-down view of the example side-by-side arrangement of canes of FIG. 5A, illustrating how the canes can be divided using laser or mechanical means to form alignment members in high-volume production;

FIG. 5C is a close-up view of an example cane showing one of the cut lines and an associated with a kerf region surrounding the cut line that accounts for material consumed during the cutting process;

FIG. 6A is similar to FIG. 5B and illustrates an example where ferrules can be formed in high volumes by arranging pairs of canes on a large support substrate to form a fabrication structure, and then cutting the fabrication structure to form the ferrules;

FIG. 6B is a top-down view of an example alignment fixture used to align the canes on the support substrate to form the fabrication structure of FIG. 6A;

FIG. 7A is a front-on view of the ferrules formed by the process of dividing up (dicing) the fabrication structure of FIG. 6A long the cut lines;

FIG. 7B is a close-up front-on view of one of the ferrules of FIG. 7A;

FIG. 8 is similar to FIG. 6A and illustrates an example alignment features in the form of spacer bars that reside between adjacent canes on the fabrication structure;

FIG. 9A is a front elevated view of an example elongate unitary structure that can be divided into alignment members for the ferrules or for the coupling sub-assemblies;

FIG. 9B is a front-on view of the unitary structure of FIG. 9A and shows the cut lines used to form four alignment members from the unitary structure;

FIG. 9C is a front-on view of the four alignment members formed using the cut lines of FIG. 9B;

FIG. 9D is a front elevated view and FIG. 9E is a close-up front-on view of one of the four alignment sub-structures formed by cutting the unitary structure of FIG. 9A, illustrating how the central cross-shaped aperture of the unitary structure serves to define first and second recessed surfaces that can serve as reference surfaces;

FIG. 10A is a partially exploded view and FIG. 10B is an assembled view of an example ferrule assembly formed using two of the alignment members of FIG. 9C;

FIG. 10C is similar to FIG. 2A and shows an example PIC assembly wherein the coupling apparatus is formed from alignment members fabricated using the unitary structure of FIG. 9A;

FIG. 11 is a close-up cross sectional view of an example optical interface device that shows a ferrule assembly operably mated to a PIC assembly, and illustrates an example of where the respective heights of the alignment members used for the ferrule assembly and the coupling apparatus are different to compensate for a fiber-to-waveguide offset in order to satisfy the fiber-to-waveguide alignment condition; and

FIG. 12 is a side view of an example alignment member for the ferrule assembly and having a height h and a width w where h>w, and showing how the alignment member can be made dual use by using it in two different orientations rotated by 90 degrees for the ferrule assembly versus the coupling apparatus of the PIC assembly.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

Cartesian coordinates are shown in some of the Figures for the sake of reference and are not intended to be limiting as to direction or orientation.

Examples of glass-based ferrules and ferrule assemblies, glass-based coupling sub-assemblies and glass-based optical interface devices are described in the aforementioned patent application, entitled “Glass-based ferrule assemblies PIC assemblies and coupling sub-assemblies for optical interface devices for photonic systems,” which as noted above is incorporated by reference herein in its entirety.

Photonic System and PIC Assembly

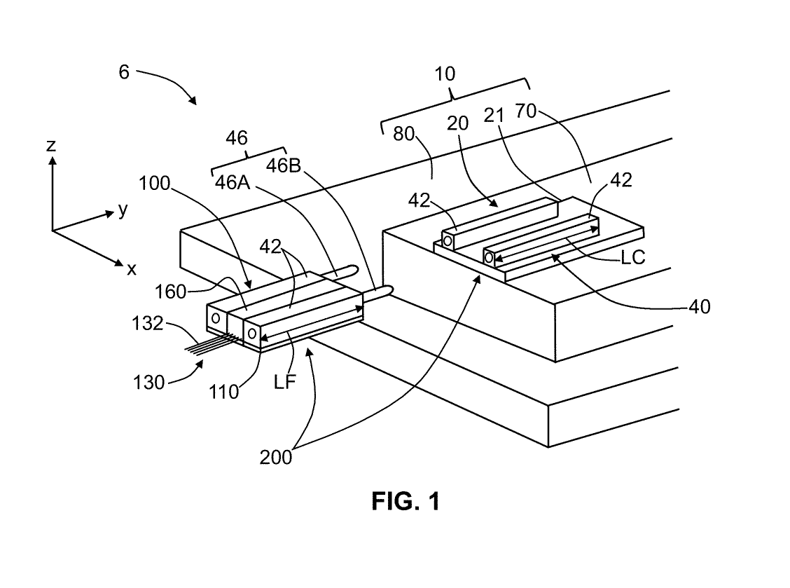

FIG. 1 is an elevated view of an example photonic system 6 in an unmated state. The photonic system 6 includes an integrated photonic assembly 10 and a ferrule assembly 100. The integrated photonic assembly includes alignment members 42 configured to be operably coupled to alignment members 42 of ferrule assembly 100 via complementary alignment features used for precision alignment during mating. The integrated photonic assembly 10 includes a PIC assembly 20 shown mounted to an interposer substrate (“interposer”) 70, which is configured to provide electrical connections between PIC assembly 20 and a printed circuit board (PCB) 80. The PIC assembly 20 includes or is configured as coupling apparatus 40. The coupling apparatus 40 includes alignment members 42.

The coupling apparatus 40 is configured to operably couple to ferrule assembly 100 via respective alignment members 42 so that the ferrule assembly is in optical communication with PIC assembly 20 of integrated photonic assembly 10 when mated. The combination of PIC assembly 20 and ferrule assembly 100 define an optical interface device 200, which is shown as being disconnected in FIG. 1. The main components of photonic system 6 are now discussed in greater detail below.

PIC Assembly and Coupling Apparatus

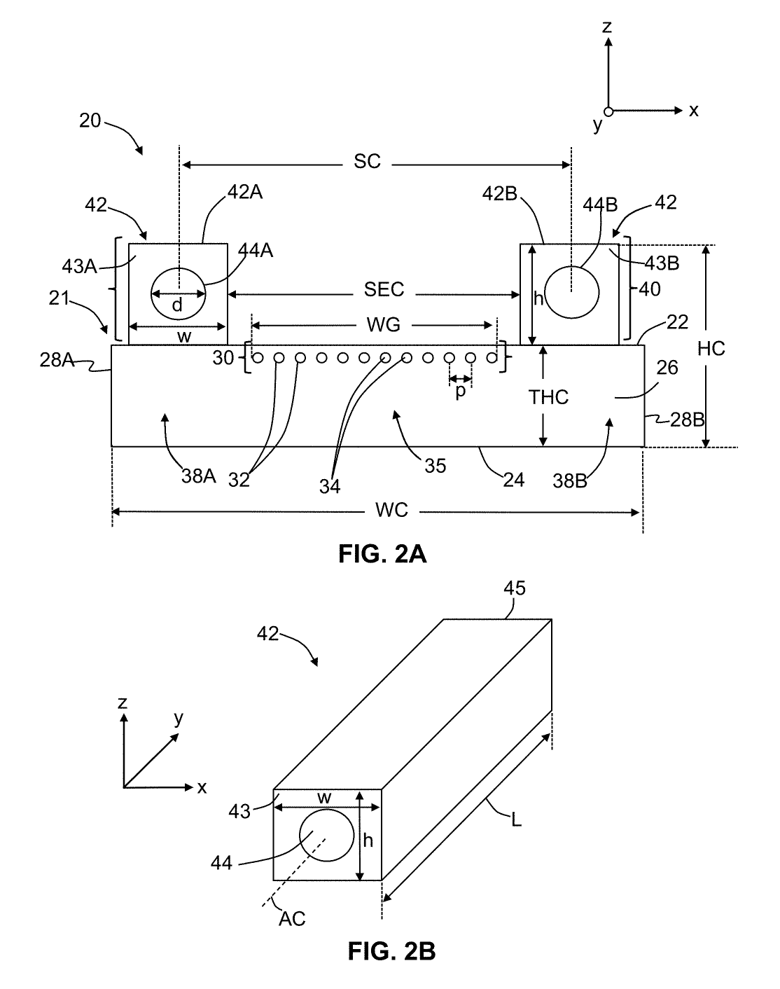

FIG. 2A is a close-up front-on view of an example PIC assembly 20. The PIC assembly 20 includes PIC 21, which has opposite upper and lower surfaces 22 and 24, a front end 26, opposite sides 28A and 28B, and supports an array 30 of optical waveguides (“waveguides”) 32 that run longitudinally in the x-direction along a medial portion 35 of the PIC. Each waveguide 32 has an end face 34 that terminates at front end 26. The end faces may be disposed at any suitable location such as near lower surface 24 or near upper surface 22 as shown in FIG. 2A. In an example, waveguides 32 are made of glass. In an example, waveguides 32 comprise channel waveguides that comprise a core and a cladding for guiding the optical signal. Also in an example, waveguides 32 are single mode, but other types of waveguides may be used with the concepts disclosed herein. Although array 30 is depicted as a single-row for explanation purposes, the array 30 may comprise multiple rows if desired for use with the concepts disclosed.

The PIC 21 can also include other components that are not shown, such as photoemitters, photodetectors, metal wiring, optical redirecting elements, electrical processing circuitry, optical processing circuitry, contact pads, etc., as is known in the art. In an example, PIC 21 is formed mainly from silicon (i.e., is silicon-based) and constitutes a silicon photonics (SiP) device. In another example, PIC 21 is formed mainly from glass, (i.e., is glass-based) and constitutes a passive planar lightwave circuit.

PIC assembly 20 includes coupling apparatus 40, which is configured to allow for the alignment of the optical coupling of the PIC assembly with ferrule 100. The coupling apparatus 40 as described below is shown in the form of a receptacle having guide holes 44 configured to receive respective alignment pins 46 from ferrule assembly 100, as shown in FIG. 1. The coupling apparatus 40 can also be configured as a plug by providing the alignment pins 46 on the coupling apparatus 40 and leaving the ferrule assembly configured with guide holes 44 for receiving the alignment pins, as discussed below. The alignment pins 46, and the guide holes 44 are examples of complementary alignment features. Thus, in general, coupling apparatus 40 and ferrule assembly 100 can have other complementary alignment features, and in particular each can have either guide holes or alignment pins.

The coupling apparatus 40 is disposed on upper surface 22 of PIC 21 and includes two spaced apart alignment members 42 (denoted 42A and 42B), and which are configured to respectively receive alignment pins 46 (denoted 46A and 46B; see FIG. 1) of ferrule assembly 100. In an example, alignment members 42A and 42B reside on upper surface 22 atop respective side portions 38A and 38B of PIC 21 near sides 28A and 28B of PIC 21. PIC 21 has alignment members 42A,42B attached thereto in a suitable manner so that a device such as ferrule assembly 100 may be mated with the assembly for making an optical connection to the optical waveguides 32 of PIC 21. Using separate alignment members 42A,42B may be advantageous since they are easier to form with precision geometry than a monolithic component. Also by using individual alignment members or components for the coupling apparatus 40 the impact due to the mismatch of CTEs of different materials (i.e., stress, strain or optical misalignment at elevated temperatures) may be reduced.

In an example, alignment members 42A and 42B reside outside of center portion 34 where array 30 of waveguides 32 resides. In an example, alignment members 42A and 42B are attached (fixed) to upper surface 22 of PIC 21 using a suitable method for the materials of the PIC 21 and the alignment members 42A,42B. By way of explanation, alignment members 42A,42B may be attached to PIC 21 using an adhesive, such as an epoxy (e.g., a UV-cured epoxy). In another example, if alignment members 42A and 42B are glass-based they may be attached (fixed) to PIC 21 using a thin absorbing film or a thin film of low melting glass or a glass frit or by using direct glass bonding techniques known in the art. Example methods of forming alignment members 42A and 42B are described below.

Coupling apparatus 40 comprises alignment members 42A and 42B and a PIC coupling assembly comprises PIC 21 with a coupling apparatus 40 (comprising alignment members 42A and 42B) attached thereto. The coupling apparatus 40 provides a precision alignment registration to the optical waveguides 32 of PIC 21 with another device such as ferrule assembly 100 or the like. Consequently, it is advantageous to have a coupling assembly that allows a precise and repeatable method of manufacture for placing and securing the coupling apparatus 40 to PIC 21 relative to the optical waveguides 32.

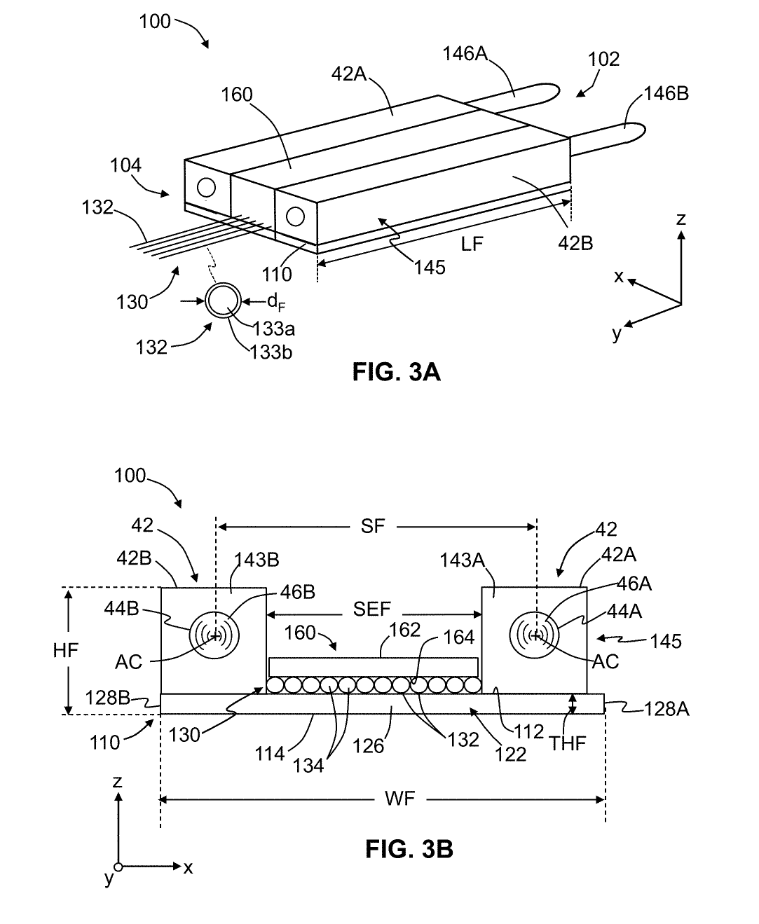

The coupling apparatus 40 as disclosed herein is either glass-based, i.e., at least a portion of the coupling apparatus is made of at least one type of glass, polymer-based, i.e., a portion of the coupling apparatus is made of at least one type of polymer, or a combination of glass and polymer as part of a “hybrid” configuration. For example, alignment members 42A and 42B can be made of a polymer while the other components such as the spacer member 162 as is FIG. 3B, as well as any alignment features and/or any support structures can be made of glass (i.e., a so-called “hybrid” configuration).

In another example hybrid configuration, alignment members 42A and 42B can be made of a polymer or glass with no other components used in the coupling apparatus. In an example, coupling apparatus is made of a single type of glass, i.e., all of the components of the coupling apparatus are made of the same glass material. In another example, the coupling apparatus 40 is made entirely of glass, but at least some of the components are made of different glass materials—for example, the alignment members 42A and 42B are made of a first glass material while all of the other components are made of a second glass material.

Alignment Members

FIG. 2B is a front elevated view of an example alignment member 42, which can be used to form coupling apparatus 40 or ferrule assembly 100. The alignment member 42 includes a longitudinal central axis AC that runs in the y-direction. The alignment member 42 also has a front end 43 and a back end 45, and has an axial guide hole 44 that runs along or generally parallel to central axis AC and that is open at least at the front end. The guide hole 44 is configured to receive alignment pin 46. As used herein, generally parallel or parallel means parallel within ±5 degrees.

Alignment members may have any suitable cross-sectional shape or size. In an example, guide hole 44 has a circular cross-sectional shape (x-z plane) to closely accommodate alignment pins 46 that in an example also has a circular cross-sectional shape. Other cross-sectional shapes can be used for guide hole 44 consistent with the cross-sectional shape of alignment pin 46. Also in an example, alignment member 42 has a substantially rectangular (x-z plane) cross-sectional shape of dimensions h and w, and further in an example has a substantially square cross-sectional shape, i.e., h=w. In one example, the cross-sectional shape of alignment member 42 has an aspect ratio h:w of no greater than 1:5 or 5:1, while in another example, the aspect ratio is no greater than 1:2 or 2:1. In another example, the aspect ratio h:w is substantially 1:1. In an example, the edges of alignment member 42 need not be perfectly square, e.g., they can be rounded.

In one example, alignment members 42A and 42B are made a molded polymer (e.g., polyphenylene sulfide or PPS), while in another example the alignment members are made of glass, such as silica, PYREX® glass, or a chemically strengthened glass. One example of chemically strengthened glass is GORILLA® glass, available from Corning, Inc., Corning, N.Y. Other chemically strengthened glasses can also be effectively employed.

In an example, dimensions h and w are in the range from 350 microns (0.35 mm) to 1500 microns (1.5 mm). In an example, h=w to within manufacturing tolerances. In an example, h and w have dimensions in the range from 500 microns to 800 microns, e.g., for small coupling sub-assemblies and small ferrules (e.g., about half the size of a standard MT connector). In an example, h=w=625 microns. The alignment member 42 also has a length L, which in an example is in the range from 2 millimeters (mm) to 20 mm, or from 2 mm to 6 mm, with an exemplary length L being nominally 3 millimeters. In an example, the length L=LC=LF, where LC is the length of coupling apparatus 40 and LF is the length of ferrule 145. However, any suitable sizes may be used with the concepts disclosed.

Dimensions of Coupling Apparatus

With reference again to FIG. 2A, alignment members 42A and 42B have a center-to-center spacing SC when secured to PIC 21 along with a precise location relative to the optical waveguides 32. Generally speaking, the center-to-center spacing SC is based upon the size and pitch of the optical waveguides 32 of the PIC along with the number of optical channels in array 30 and the arrangement of the optical waveguides 32 of the array 30. In an example, the spacing SC may be between 2 mm and 10 mm, with an exemplary spacing SC of between 2 mm and 3 mm, e.g., 2.3 mm. The alignment members 42A and 42B also have an inside edge-to-edge spacing SEC of between 1 and 5 mm or between 1.5 mm and 1.8 mm, with an exemplary spacing SEC of nominally 1.675 mm. However, any suitable spacing is possible according to the concepts disclosed.

The array 30 of waveguides 32 also has a width WG. By way of example, an array 30 of n=12 optical waveguides with a pitch p=127 microns is WG=(n)(p)=(12)×(127)=1524 microns. Other suitable values for the pitch p can be used, e.g., 125 microns or 250 microns, and in an example the number n of waveguides 32 can be from n=2 to n=24, but other suitable values are possible. In an example, PIC 21 has a thickness THC of between 300 and 1000 microns, with an exemplary thickness THC being nominally 750 microns. The coupling apparatus 40 also has a height HC=THC+h and a length LC (see FIG. 1).

Thus, the overall dimensions of coupling apparatus are height HC, width WC and length LC. In an example, these dimensions can be about the same as that for a standard MT connector, e.g., HC×WC×LC=3 mm×7 mm×8 mm, or can be about half the size, e.g., 1.5 mm×3.5 mm×4 mm. In an example, the dimensions HC×WC×LC can in the range from 5 mm×15 mm×20 mm to 1 mm×3 mm×2 mm, but other dimensions are possible.

Example Ferrule Assemblies

FIG. 3A is a back-side elevated view and FIG. 3B is a front-on view of an example ferrule assembly 100. With reference to FIGS. 3A and 3B, ferrule assembly 100 has a front side or front end 102 and a back side or back end 104. The ferrule assembly 100 includes a support substrate 110 having generally parallel upper and lower surfaces 112 and 114, opposite front and back ends 122 and 124, a central portion 126, and opposite edges (sides) 128A and 128B.

In an example, support substrate 110 is in the form of a planar sheet and is made of any suitable material. By way of example, the support substrate 110 may be a glass, such as a fusion-drawn glass, which could be chemically strengthened glass. Another method for making support substrate 110 as a planar glass sheet is by floating molten glass on a bed of molten metal. Another method of making support substrate 110 as a planar glass sheet is by using a slot draw process where molten glass flows out of a slot at the bottom of a refractory furnace. Yet another method of making the support substrate 110 as a planar glass sheet is by rolling a slab a glass into its final thickness. Of these, fusion-drawn glass forming may be preferred in certain applications due to its flatness and precision. Although, the term “planar” is used, the support substrate 110 may include fiber alignment features such as v-grooves or other geometry for aligning and fixing the optical fibers in a desired spacing. For instance, the support substrate 110 may comprise fiber alignment features etched into the surface for seating and spacing the optical fibers.

The ferrule assembly 100 includes an array 130 of optical fibers 132 each having core 133a, a cladding 133b surrounding the core (see close-up inset in FIG. 3A), and an end face 134. The optical fibers 132 reside on upper surface 112 of substrate 110 at central portion 126 and run in the y-direction. In an example, fiber end faces 134 are terminated near the front end 122 of support substrate 110. The optical fibers 132 in array 130 define a pitch p′. In an example, optical fibers 132 each have a diameter d_{F}, which in one example is 125 microns. In an example, optical fibers 132 are arranged side-by-side so that the optical fiber pitch p′ of array 130 is substantially equal to the fiber diameter d_{F}. In another example, the optical fiber pitch is 250 microns. In an example, optical fibers 132 are single mode fibers but other types of optical fibers may be used with the concepts disclosed.

Also in an example, optical fibers 132 are small-clad optical fibers, i.e., the cladding 133b of optical fiber 132 is substantially smaller than that of the cladding used in a conventional optical fiber. By way of explanation, a standard single mode optical fiber can have a core diameter of about 10 microns and a cladding diameter ranging from 50 microns up to 125 microns. An advantage of using small-clad optical fibers for optical fibers 132 is that the pitch p′ can be made smaller than for conventional optical fibers, and can be made as small as the diameter d′ of the optical fiber, where the diameter d_{F} is defined by the diameter of cladding 133b. Thus, small-clad optical fibers 132 can be more densely packed in ferrule assembly 100 while also affording greater latitude in matching the period p′ of the optical fibers to the period p of waveguides 32 of PIC assembly 20. Although ferrule assembly 100 is depicted with a single-row of optical fibers, the ferrule assembly 100 may have multiple rows of optical fibers to mate with a suitable PIC coupling assembly.

The ferrule assembly 100 also includes first and second spaced apart alignment members 42, denoted 42A and 42B, and as described above in connection with coupling apparatus 40. In an example, guide holes 44A and 44B respectively support alignment pins 46A and 46B. As discussed above, alignment pins 46A and 46B are configured to be received by respective guide holes 44A and 44B of alignment members 42A and 42B of coupling apparatus 40 so that ferrule assembly 100 can be aligned and mate to the coupling apparatus. The coupling results in the optical connection of optical interface device 200, with optical fibers 132 of the ferrule assembly being axially aligned with corresponding waveguides 32 of PIC 21 of PIC assembly 20. In an example, alignment pins 46A and 46B are made of a metal. The alignment members 42A and 42B reside on upper surface 122 of support substrate 100 adjacent respective sides 128A and 128B.

In an example, alignment members 42A and 42B are fixed to upper surface 122 using an adhesive, such as an epoxy (e.g., a UV-cured epoxy). In another example, alignment members 42A and 42B are fixed to upper surface 112 using a thin absorbing film or a thin film of low melting glass or glass frit or direct glass bonding techniques known in the art. The alignment members 42 and support substrate 110 define a ferrule body (“ferrule”) 145. In an example, alignment members 42A and 42B reside outside of center portion 126 where array 130 of waveguides 32 resides.

The array 130 of optical fibers 132 of ferrule assembly 100 is configured to optical couple to array 30 of waveguides 32 when ferrule assembly 100 is operably coupled to coupling apparatus 40 of PIC assembly 20. Thus, in an example, the optical fiber pitch p′ is equal to the waveguide pitch p, and the number n′ of optical fibers 132 is equal to the number n of waveguides 32.

In an example, ferrule assembly 100 includes a securing member 160 that has an upper surface 162 and a lower surface 164. The securing member 160 resides atop optical fiber array 130 with lower surface 164 in contact with optical fibers 132 to keep the optical fibers in place on upper surface 112 of support substrate 110, as shown in FIG. 3B. In an example, securing member 160 is in the form of a planar sheet. In an example, the width of securing member 160 is substantially the same as the width of optical fiber array 130. In an example, optical fiber array 100 spans the entire space between alignment members 42A and 42B.

Securing member 160 may be used as a jig to ensure the proper spacing and placement of alignment members 42A and 42B. The securing member 160 can also be used as a temporary fixture to insure proper placement and permanent fixing of optical fibers 132. In another example, the securing member 160 can be used as a permanent fixture to optical fiber array 130 and/or to alignment members 42A and 42B using adhesive, such as an epoxy (e.g., a UV-cured epoxy). In another example, securing member 160 can be fixed to alignment members 42A and 42B and/or to optical fiber array 130 using a thin absorbing film or a thin film of low melting glass or glass frit or direct glass bonding techniques known in the art.

In an example, support substrate 110 is made of black glass, a glass doped with metal such as iron or titanium, which can facilitate the use of a glass fusion process in assembling ferrule assembly 100. In an example, support substrate 100 can have a layer of glass that has a relatively low melting temperature (i.e., “low-melt glass”), e.g., of about 300 C. This can enable the use of bonding in an oven or other low-temperature non-localized heat source rather than using a laser or other relatively high-temperature and localized heating means.

Ferrule assembly 100 as disclosed herein is also glass-based or a combination of glass and polymer as part of a “hybrid” configuration, i.e., at least a portion of the coupling apparatus is made of at least one type of glass.

In an example, the support substrate 110, alignment members 42A and 42B and the optional securing member 160 of ferrule assembly 40 can be made of glass only, while in another example can be made with only some of the components being glass as part of a “hybrid” configuration. For example, support substrate 110 can be made of glass while alignment members 42A and 42B can be made of a polymer (i.e., a so-called “hybrid” configuration). In an example, ferrule 145 is made of a single type of glass, i.e., the same glass material. In another example, ferrule 145 is made entirely of glass, but at least some portions of the ferrule are made of different glass materials—for example, support substrate 110 is made of a first glass material while the two alignment members 42A and 42B are made of a second glass material. For instance, the first glass material may be may glass sheet made using a fusion glass process with a first glass material and the alignment members are made using a draw glass process with a second glass material.

Thus, in an example, optical interface device 200 has a hybrid construction wherein at least a portion of the optical interface device is made of glass since the ferrule assembly 100 and coupling apparatus 40 are each glass-based, as described above.

Dimensions of Ferrule Assembly

With reference to FIG. 3B, alignment members 42A and 42B may have a center-to-center spacing SF and edge-to-edge spacing SEF with suitable dimensions. In an example, SF=SC and SEF=SEC. The support substrate 110 has a thickness THF, which in an example is in the range from 0.3 millimeter to 2 millimeter, but other dimensions are possible. The ferrule assembly 100 has a total or overall width WF and an overall height HF, and a length LF.

Ferrule assembly 100 can be made to have a size that is substantially the same as a coupling apparatus 40, i.e., it can have a size of a standard MT ferrule and can be as small as about half the size of a standard MT ferrule. Thus, in an example, the dimensions HF×WF×LF can be in the range from 3 mm×7 mm×8 mm to 1.5 mm×3.5 mm×4 mm.

Method of Forming Alignment Members

Methods of forming alignment members 42 for use in forming coupling apparatus and ferrule 145 of ferrule assembly 100 are now discussed.

As discussed above, alignment member 42 has height and width dimensions h and w that may be any suitable values. In an example, the height and width dimensions h and w may be in the range from 1.5 millimeters to 350 microns (0.350 mm) and define an aspect ratio (h;w) of no greater than either 1:5 or 5:1, or no greater than 1:2 or 2:1. Likewise, as discussed above, an exemplary length L of alignment member 42 is 3 millimeters. The alignment member 42 is thus a relative small part that can be difficult to manufacture with precision.

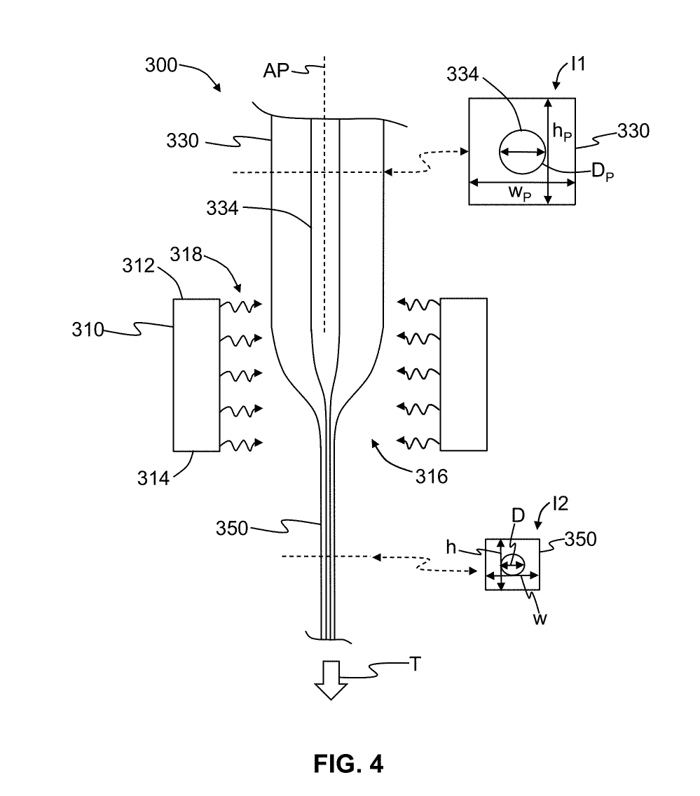

In an example, alignment member 42 is formed using a drawing process such as used to form optical fibers. FIG. 4 is a cross-sectional view of an example drawing system 300 used in an example method of forming alignment member 42. The drawing system 300 includes a cylindrical heater 310 having an input end 312, and output end 314 and an interior 316. The cylindrical heater 310 generates heat 318 in interior 316.

There are multiple methods known in the art to create a desired glass preform 330. In one example, a thick-walled tube has its outer surface mechanically machined. In another example, soot can be pressed onto a central rod to form a monolithic body and then the soot machined before the body is consolidated into glass. Another method is by an extrusion process. Thus, glass preform 330 can be formed by at least of one the following processes: mechanical grinding, polishing, extrusion, soot pressing, consolidation, soot pressing, and machining.

An example glass preform 330 is rectangular and has cross-sectional width and height dimensions of h_{P} and w_{P} (see close-up inset I1), which defines an aspect ratio h_{P}:w_{P}. The preform 330 also has a central axis AP and longitudinal bore or hole 334 of diameter D_{P}. The longitudinal bore or hole 334 need not be centered on central axis AP. Preforms of other shapes can also be used, e.g., generally circular, oval, etc., with a flat portion for mounting to a planar surface.

The preform 330 is arranged adjacent input end 312 of cylindrical heater 310 and then inserted through interior 316. The heat 318 heats preform 330, which is subjected to an axial tension T. The heat 318 softens the portion of preform 330 within interior 316 by bring heated portion of the preform to its melting temperature. The axial tension T causes preform 330 to be drawn down into a drawn preform section 350, which has substantially the same aspect ratio of the preform. The cross-sectional size reduction from preform 330 to drawn preform section 350 can be from 10× to 400×, with 50× being an exemplary size reduction.

Thus, for forming alignment member 42 to have desired height and width dimensions h and w, the preform height and width dimensions h_{P} and w_{P} can be from 10× to 400× as large. In a specific example, for desired height and width dimensions of h=w=625 microns and for a drawing process with a 50× size reduction, the preform height and width dimensions h_{P} and w_{P} can both be 31.25 mm.

The drawing process can be carried out to micron-sized tolerances, so that desired alignment member dimensions, which are typically measured in the many hundreds of microns, can be fabricated to relatively high tolerances, i.e., small percentage of the width w and height h (e.g., to 1% or 0.05% or 0.02% or even 0.01%).

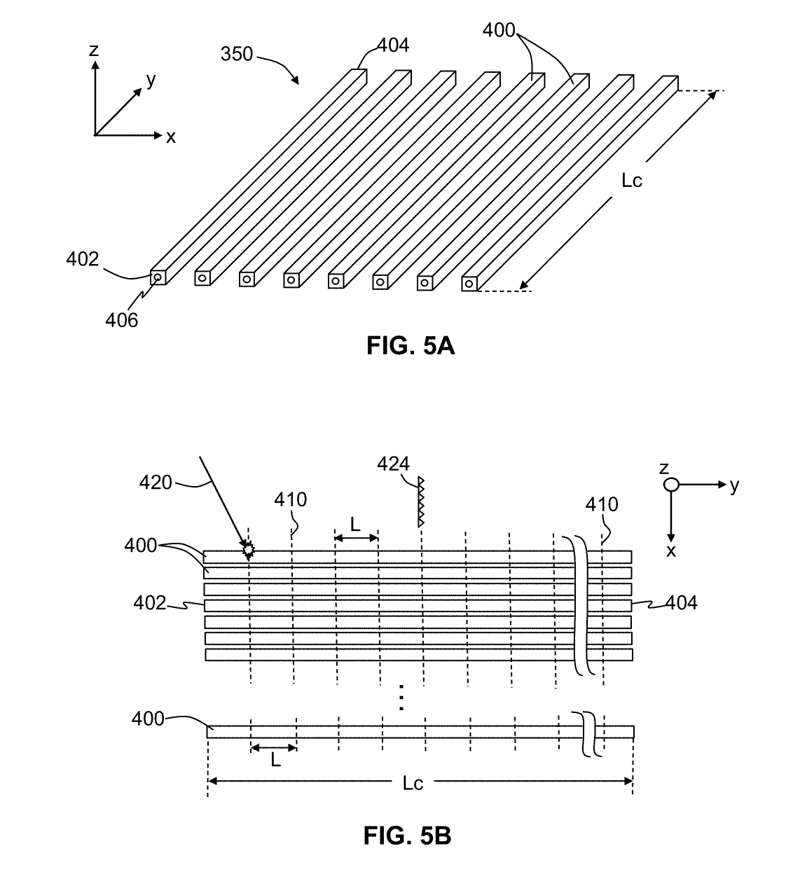

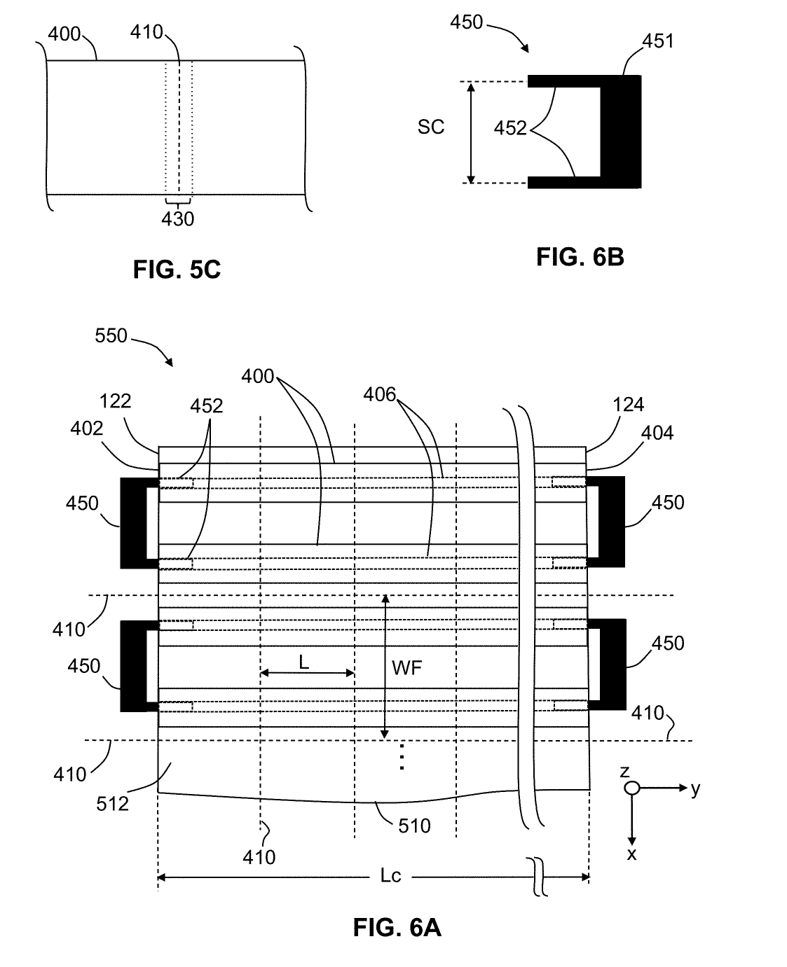

FIG. 5A is an elevated view of multiple canes 400 arranged side by side. The canes 400 are formed by dividing up drawn preform section 350 into pieces. The canes 400 have front and back ends 402 and 404 and a longitudinal bore 406 defined by the longitudinal bore 334 of preform 330. The canes 400 each have a length Lc, which can be relatively long as compared to the height and width dimensions h and w, e.g., Lc can be 1000× longer that the dimensions h or w. In an example, the length Lc is 12 millimeters or longer, and in an example is about 1 meter. In an example, tens or hundreds or thousands of canes 400 can be formed from a given drawn preform section 350. Each cane 400 can then be cut into a large number of smaller sections to form alignment members 42. For example, for 3 millimeters long alignment members 42, a single cane 400 of length Lc=1 meter can be used to form about 330 alignment members.

FIG. 5B is top-down view of the canes 400 of FIG. 5A illustrating an example method of fabricating alignment members 42 in high volume. The method includes arranging canes 400 in a side-by-side, closely-spaced configuration. In an example, tens or hundreds or thousands of canes 400 can be so arranged. The canes 400 are arranged to lie in the y-direction and in an example are tightly packed with little or no space in the x-direction. Cut lines 410 are defined that run the x-direction based on the desired length L of alignment members 42. Thus, cut lines 410 are spaced apart in the y-direction by a distance L, where in an example L is between 2 mm and 10 mm, with 3 mm being an exemplary value. The cut lines 410 represent locations where canes 400 are to be cut in the x-z plane. Such cuts are referred to herein as “cross-sectional cuts.”

The cuts can be made using, for example light-based means, e.g., a cutting laser beam 420, or mechanical means, such as a saw (e.g., a diamond-bladed saw) 424. FIG. 5C is a close-up view of one of the cut lines 410 and shows a kerf region 430 surrounding the cut line and that accounts for an amount of material consumed during the cutting process.

FIG. 6A is a top down view of an example arrangement of canes 400 for fabricating ferrule assemblies 100 in large volumes. The canes 400 are disposed on an upper surface 512 of a large glass support sheet 510 to form a fabrication structure 550. The large support sheet 510 is glass and is made of the same glass material as support substrate 110. The canes 400 are arranged to lie in the y-direction and are spaced apart in the x-direction. The alignment and spacing of pairs of canes 400 correspond to the desired alignment and spacing SC of alignment members 42A and 42B of ferrule 145.

In an example, an alignment fixture 450 facilitates the alignment and spacing of canes 400 on fabrication structure 550. FIG. 6B is a close-up top-down view of an example alignment fixture 450 that has a main body portion 451 with two prongs 452 extending in the same direction therefrom. The prongs 452 have a center-to-center spacing SC, as shown in FIG. 6B. Two alignment fixtures 450 are used for each pair of canes 400; one at the front ends 402 and one at the back ends 404. The prongs 452 are inserted into and reside within respective bores 406 of the two adjacent canes 400 in the pair of canes. It is noted that the alignment fixture 450 of FIG. 6B can also be used to position and align alignment members 42A and 42B on PIC 21 to form coupling apparatus 40.

The arrangement of canes 400 of FIG. 6A includes cut lines 410 that run in both the x-direction and the y-direction on fabrication structure 550. The cut lines 410 that run in the x-direction are spaced apart in the y-direction by the distance L while the cut lines that run in the y-direction are spaced apart in the x-direction by a distance WF, which as noted above is the overall width of ferrule 145 and thus the overall width of ferrule assembly 100.

Once canes 400 are properly positioned on upper surface 512 of large support sheet 510, they are secured (attached) to the upper surface. In an example, the securing of canes 400 is accomplished using an adhesive, such as an epoxy (e.g., a UV-cured epoxy) or a thin absorbing film or a thin film of low melting glass or a glass frit or by using direct glass bonding techniques known in the art. The alignment fixtures 450 can then be removed from the front and back ends 402 and 404 of the pairs of canes 400. Many pairs of canes 400 can be aligned and secured in this manner, e.g., tens or hundreds, on a single large support sheet 510.

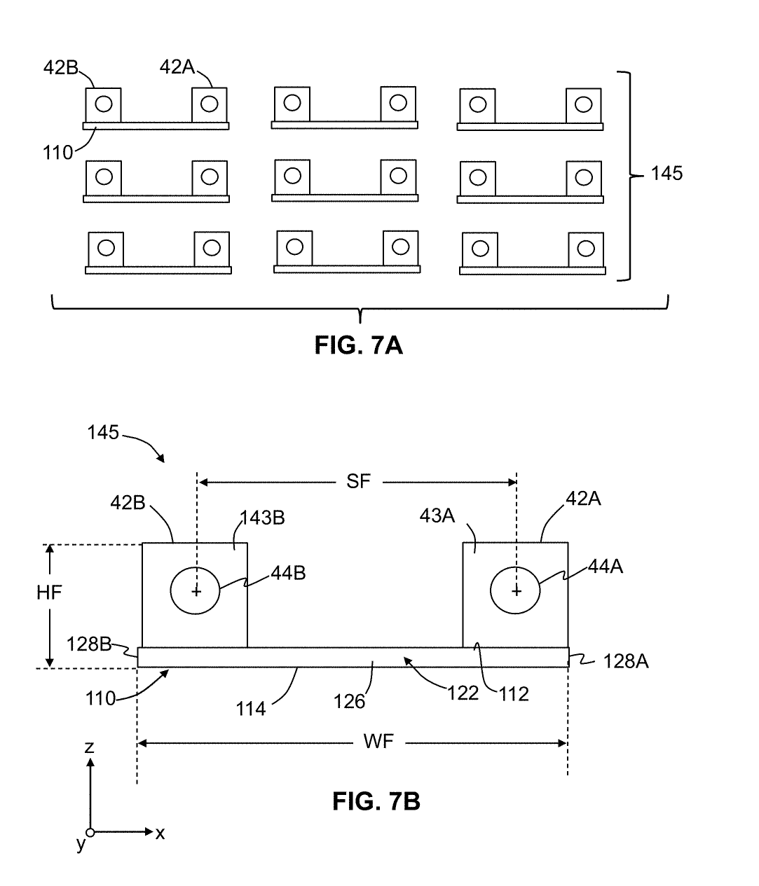

Once the pairs of canes 400 are secured in their aligned position on upper surface 512 of large support sheet 510, the resulting fabrication structure 550 is cut along the (x, y) cut lines 410 to define separate ferrules 145, as shown in FIGS. 7A and 7B. Thus, fabrication structure 550 is diced along cut lines 410. The divided up or “diced” sections of the support sheet 510 define the individual support substrates 110 of ferrules 145, while the pairs of cut (diced) canes 400 define the individual alignment members 42A and 42B.

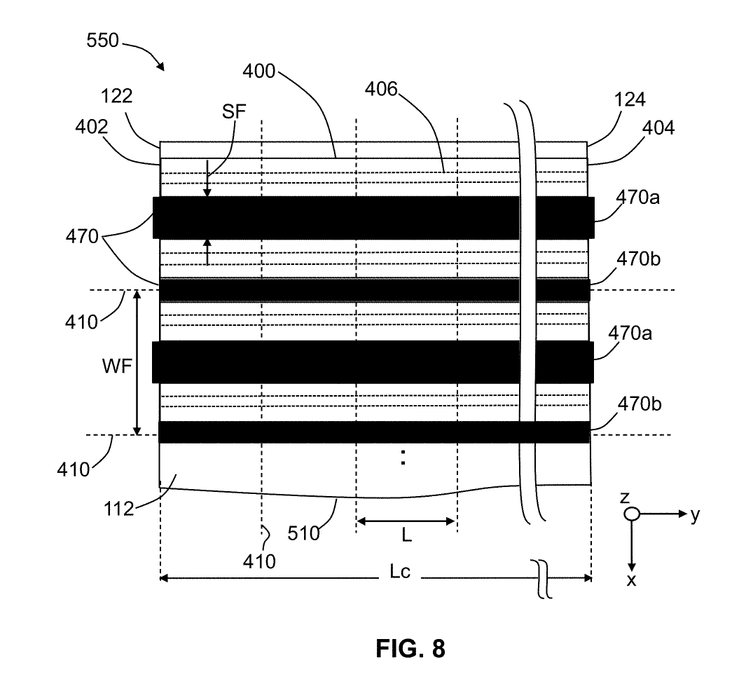

FIG. 8 is similar to FIG. 6A and illustrates an example fabrication structure wherein the alignment fixture 450 is in the form of spacer blocks 470 that reside between adjacent canes 400. One set of spacer blocks 470a defines the center-to-center spacing SC, while another set of spacer blocks 470b defines the portion of the structure to be used for the y-direction cut lines 410 and are spaced apart by distance WF. The spacer blocks 470 can be made any material that is sufficiently firm to define the needed spacing. Once the canes 400 are secured to the upper surface 512, the spacer blocks 470 can be removed before cutting. In an example, the spacer blocks 470 can be made of a plastic or polymer and can be formed by a precision molding process, e.g., injection molding. In other examples, the spacer blocks 470 can be made of metal or glass.

Unitary Structure for Forming Alignment Members

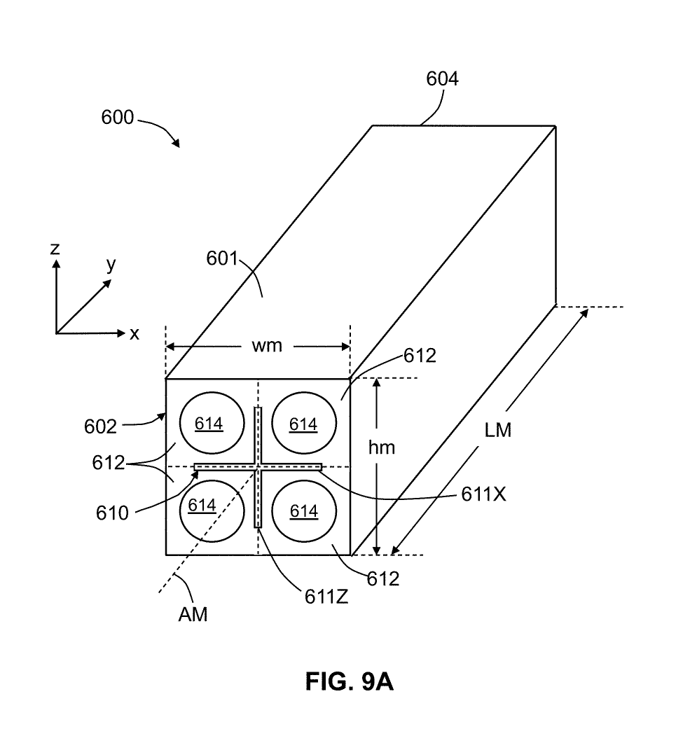

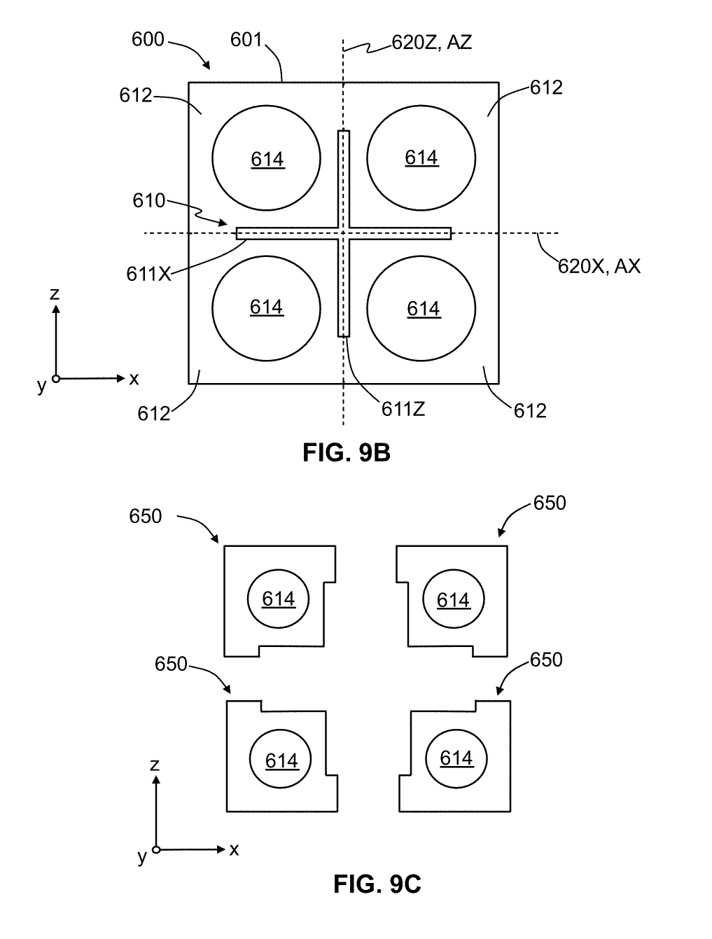

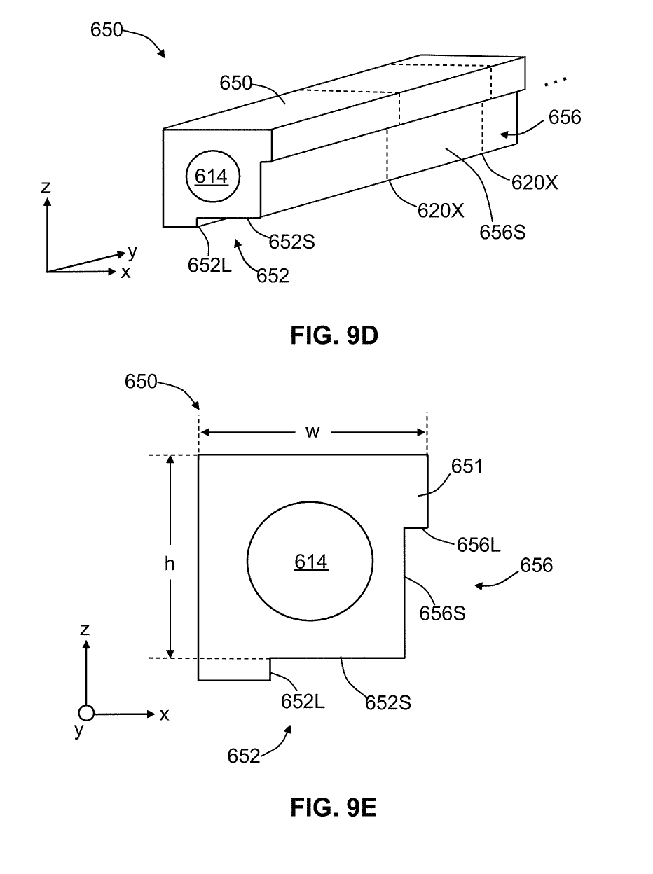

FIG. 9A is an elevated view and FIG. 9B is a front-on view of an example elongate monolithic body 600 that can be used to form multiple alignment members 42. In an example, the monolithic body 600 is made using a mold process (e.g., injection molding) or by 3D printing process or by an extrusion process. In an example, monolithic body 600 is made from a plastic or polymer, e.g., a thermoplastic or a thermosetting polymer. Thus, in an example, monolithic body 600 is made from a single material using a single process so that it is made as a single piece of a single material in one process step, as opposed to combining two or more pieces of the same or different materials using multiple process steps. In an example, the mold process is the same or similar as that described in U.S. Patent Application Publication No. 2015/0355419, which is incorporated by reference herein.

The monolithic body 600 has with a front end 602, a back end 604 and includes a central body axis AM that runs in the long direction (i.e., the y-direction). The monolithic body 600 also includes and a longitudinal central aperture 610 centered on the central axis AM. The central aperture 610 has cross shape with a two orthogonal sections, namely an x-section 611X that runs in the x-direction and a z-section 611Z that runs in the z-direction. Both the x-section 611X and the z-section 611Z also run the length of monolithic body, i.e., in the y-direction from front end 602 to back end 604. The x-section 611X has a central axis AX that runs in the x-direction and the z-section 611Z has a central axis AZ that runs in the z-direction. The central axes AX and AZ are thus orthogonal to central body axis AM and intersect at the central body axis. In an example, x-section 611X and z-section 611Z have the same size and shape, though generally they need not have the same size and shape.

The x-section 611X and the z-section 611z of cross-shaped central aperture 610 divides monolithic body 600 into four quadrants 612. Each quadrant 612 includes a longitudinal bore 614 that is offset from the central body axis AM. In an example, the longitudinal bore 614 can be centered in quadrant 612, but can also be off-centered as well. The monolithic body 600 has width wm, height hm and a length LM. When using extrusion to form monolithic body 600, the length LM can be very large as compared to the width w and height h, e.g., 0.5 meters or 1 meter. When using a molding or 3D printing process to form monolithic body 600, the length LM can substantially smaller, e.g., in the range of 3 mm to 50 mm. In an example, the width wm is about 2w (i.e., twice the width of alignment member 42) and the height hm is about 2h (i.e., twice the height of alignment member 42). Thus, in an example, the width wm and height hm are both in the range from about 700 microns to about 3000 microns.

In an example, monolithic body 600 has an outer cross-sectional shape that is substantially rectangular, and in an example is square. In other examples, monolithic body 600 can have an outer cross-sectional shape that is non-rectangular shape, e.g., substantially circular, polygonal, etc. In an example, the outer cross-sectional shape of monolithic body 600 can include rounded corners.

FIG. 9B is a close-up front-on view of monolithic body 600 and shows cut lines 620X and 620Z that run along the x-section central axis AX and the z-section central axis AZ, respectively. The cut lines 620X and 620Z define locations where monolithic body 600 can be cut using known means, such as laser cutting or mechanical cutting. The cut line 620X of FIG. 9B is used to define a cut in the x-y plane that includes central axis AC, while the cut line 620Z of FIG. 9B is used to define a cut in the y-z plane that also includes central axis AC.

FIG. 9C is a front-on view of the monolithic body 600 after having been divided up along the cut lines 620X and 620Z of FIG. 9B to form four elongate alignment sub-structures 650. FIG. 9D is an elevated view and FIG. 9D is a close-up front-on view of one of the alignment sub-structures 650, which in an example has a body 651, height and width dimensions of h and w, i.e., the same as alignment member 42. Each alignment sub-structure 650 formed from monolithic body 600 has a first side 652 and a second side 656 that resides adjacent the first side. The first and second sides 652 and 656 include respective recessed surfaces 652S and 656S defined by respective lips 652L and 656L. The other alignment sub-structures 650 formed from monolithic body 600 have the same basic configuration, as can be seen in FIG. 9C.

FIG. 9D shows example cut lines 620X that run in the x-direction at different y-locations and define cross-sectional cut locations, i.e., where cross-sectional cuts can be made in different x-z planes. The four alignment structures can be cut cross-sectionally at the spaced-apart cut locations 620X to form sections of length L. The cut sections can be used as alignment members 42, with longitudinal bores 614 serving as guide holes 44.

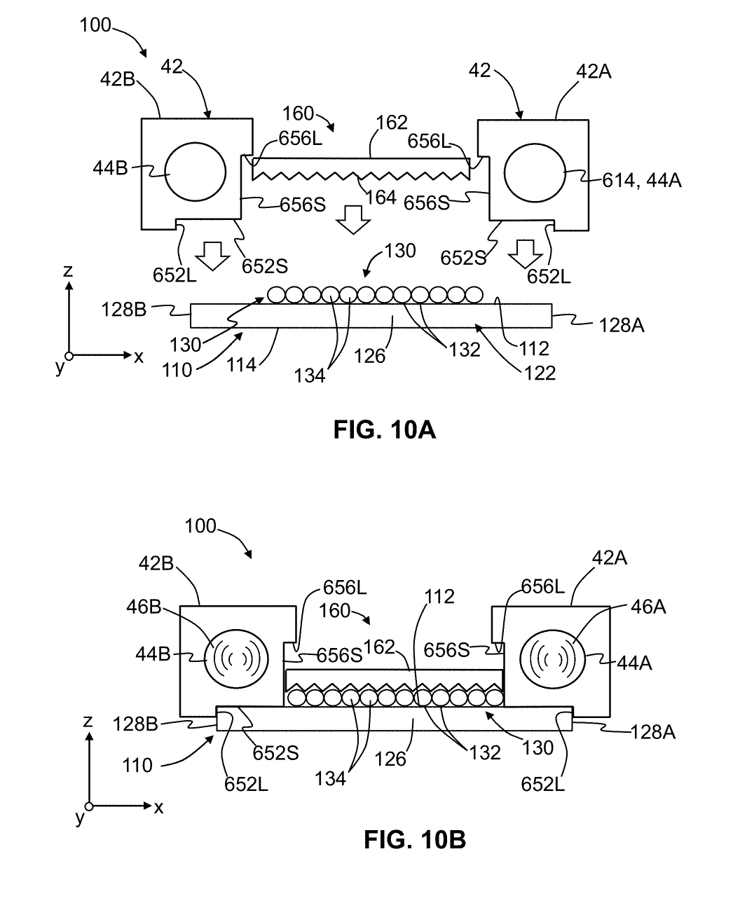

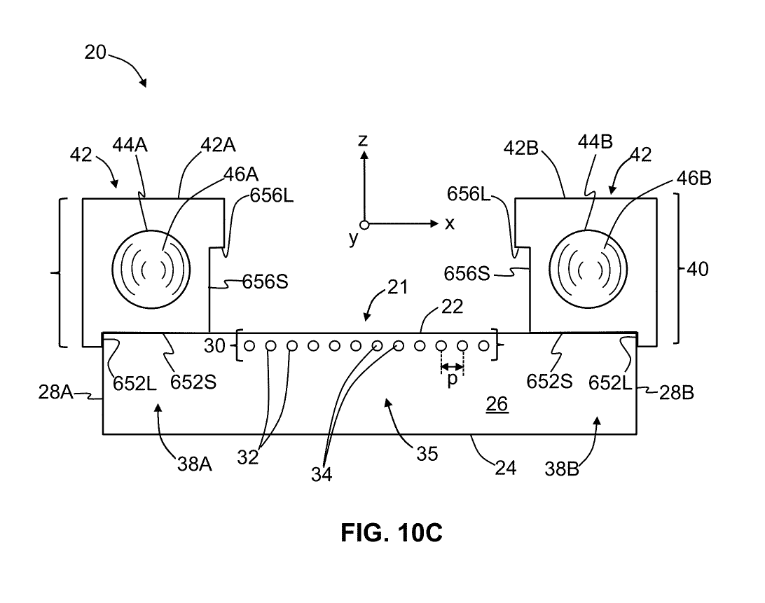

FIG. 10A is a partially exploded view and FIG. 10B is an assembled view of an example ferrule assembly 100 similar to that shown in FIG. 3B and that utilizes two cut sections of alignment sub-structures 650 as the alignment members 42A and 42B. The recessed surfaces 652S of alignment members 42A and 42B reside upon the upper surface 112 of support substrate 110, with lips 656L residing adjacent or in contact with respective sides 128 of the support substrate. FIG. 10B shows alignment members 42A and 42B operably supporting respective alignment pins 46A and 46B.

FIG. 10C is similar to FIG. 2A and illustrates an example PIC assembly 20 that utilizes the alignment members 42 fabricated from monolithic body 600 to form coupling apparatus 40. The recessed surfaces 652S of the alignment structures 42A and 42B reside upon the upper surface 22 of PIC 21, with the respective lips 652L residing against respective sides 28A and 28B.

The precision formation of monolithic body 600 and the precise division of the monolithic body to form alignment sub-structures 650 results in the recessed surfaces 652S and 656S and corresponding lips 652L and 656L being useful as reference and/or alignment features for precise positioning and aligning alignment members 42 on upper surface 112 of support substrate 110. In an example, lips 656L of the two alignment sub-structures 650 can be formed so that they contact the upper surface of securing member 160 while the outside edges of the securing member contact the recessed surfaces 656S of the alignment sub-structures. Thus, recessed surfaces 652S and 656S of each alignment member 42 can each be used as a datum during the fabrication of ferrule 145 or coupling apparatus 40.

Dual-Use Alignment Member

When forming optical interface device 200, the waveguides 32 of PIC 21 need to be optically aligned with optical fibers 132 of ferrule assembly 100 when the alignment features of ferrule assembly and coupling apparatus operably engage. This is referred to as the fiber-to-waveguide alignment condition.

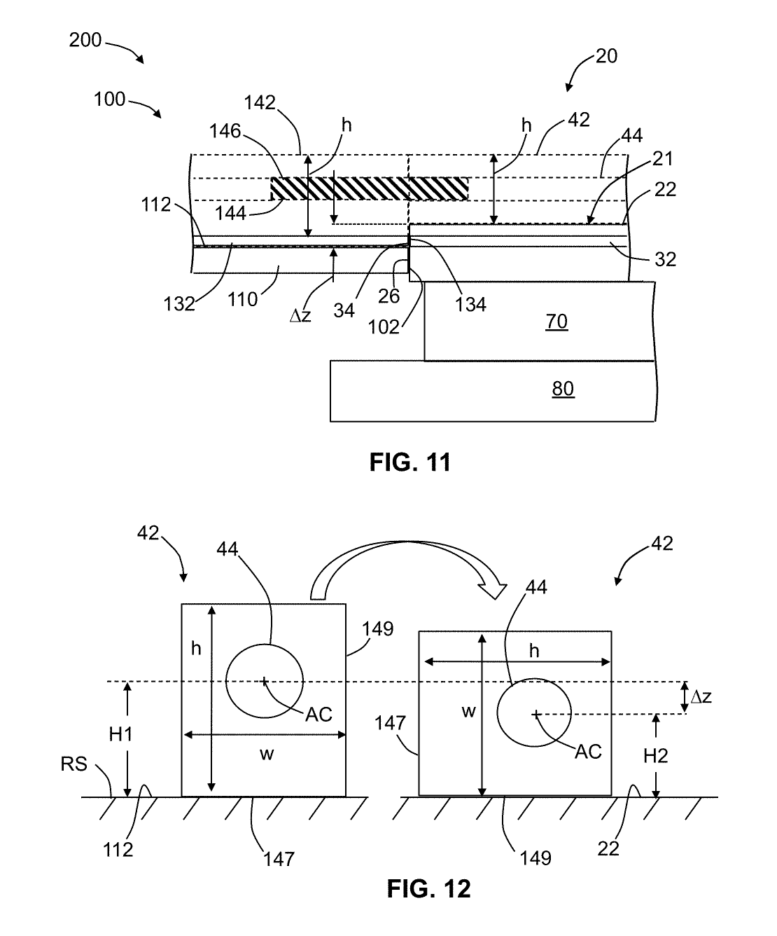

FIG. 11 is a close-up cross-sectional view of an example optical interface device 200 that shows ferrule assembly 100 operably mated with PIC assembly 40 and illustrates an example of where the height h of alignment members 42 of the ferrule assembly is greater than the height h of alignment members 42 used for PIC assembly. The alignment members 42 are shown in phantom in FIG. 11 since they would not otherwise appear in a cross-sectional view that includes waveguides 32 and optical fibers 132. The different heights h are selected to account for the (vertical) offset between the upper surface 112 of support substrate 110 and the upper surface 22 of PIC 21 when the waveguides 32 and optical fibers 132 are optically aligned. This vertical offset is denoted Δz in FIG. 11 and is referred to herein as the fiber-waveguide offset.

FIG. 12 shows a side view of an example alignment member 42 residing on a reference surface RS, which can be upper surface 112 of substrate 110 or upper surface 22 of PIC 21. The alignment member 42 has a side 147 with a “length” w and adjacent side 149 with a “length” h. On the left side of FIG. 12, alignment member 42 is shown with side 147 as the “bottom” side, i.e., resting on or facing reference surface RS. On the right side of FIG. 12, alignment member 42 is shown with side 149 as the bottom side, i.e., resting on or facing the reference surface. Thus, in FIG. 12, the alignment member 42 has been rotated by 90 degrees.

The two orientations of alignment member 42 in FIG. 12 show that the central axis AC of guide hole 44 resides at a distance H1 from side 147 and resides a distance H2 relative from side 149, wherein H1>H2.

In an example, alignment member 42 is configured for dual use, i.e., it can be used in either ferrule assembly 100 or coupling apparatus 40 even though the geometric requirements for meeting the fiber-to-waveguide alignment condition are different for ferrule assembly 100 versus coupling apparatus 40. For alignment member 42 to be dual use, the difference in the heights ΔH=H1−H2 is selected to be substantially the same as the fiber-waveguide offset Δz. Thus, alignment members 42 with the same cross-sectional geometry and with different heights H1 and H2 can be used for both ferrule 145 and coupling apparatus 40 simply by rotating the alignment members used to form the ferrule relative to orientation used in the coupling apparatus.

Note that the height h of the alignment members 42 used for coupling apparatus 40 is the width w of the alignment members used for ferrule assembly 100. Likewise, the width w of the alignment members 42 used for coupling apparatus 40 is the height h of the alignment members used for ferrule assembly 100.

Alignment member 42 can have a square cross-sectional shape (i.e., h=w), as long ΔH=Δz, which requires that H1 and H2 not be equal. It is also noted that the description of the “dual use” alignment member 42 set forth above can be made with reference to first to coupling assembly 40 and then to ferrule assembly 100 without loss of generality.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of forming a ferrule or a coupling apparatus, comprising:
drawing a glass preform to form a drawn glass preform section with a size reduction, wherein the glass preform has a first longitudinal alignment feature;
dividing the drawn glass preform section into at least first and second alignment members, with each alignment member having a length L that is in the range from 2 millimeters to 20 millimeters; and
attaching the first and second alignment members in a spaced apart configuration to an upper surface of either: i) a glass support substrate to form the ferrule or ii) a photonic integrated circuit (PIC) to form the coupling apparatus.

2. The method according to claim 1, wherein the act of attaching the alignment members to the either the support substrate or the PIC is performed using either an adhesive or a thin absorbing film or a thin film of low melting glass or a glass frit or a direct glass bonding process.

3. The method according to claim 1, wherein the act of dividing the drawn glass preform section is performed using one or more of a laser beam, a saw or mechanically scoring and cleaving.

4. The method according to claim 1, wherein the act of dividing the drawn glass preform section comprises:
dividing the drawn glass preform section into a plurality of canes;
arranging the plurality of canes in a side-by-side configuration; and
cutting the plurality of canes into the alignment members of length L.

5. The method according to claim 1, wherein the size reduction is between 10× and 400×.

6. The method according to claim 1, further comprising forming the glass support substrate using a fusion draw process.

7. The method according to claim 1, further comprising forming the glass preform using at least one of the following processes: mechanical grinding, polishing, extrusion, soot pressing, consolidation, etching, and machining.

8. A method of forming glass-based ferrules for a ferrule assembly, comprising:
drawing a glass preform to form a drawn glass preform section with a size reduction, wherein the glass preform has a first longitudinal alignment feature, and wherein the drawn preform section has a second longitudinal alignment feature defined by the first longitudinal alignment feature;
dividing the drawn glass preform section into a plurality of canes;
securing the plurality of canes on an upper surface of a glass support sheet to define a fabrication structure, wherein the canes are arranged in spaced-apart pairs; and
cutting the fabrication structure including the plurality of canes and the glass support sheet to form a plurality of the ferrules, with each ferrule having a pair of spaced apart glass alignment members defined by canes and supported by a glass support substrate defined by the glass support sheet.

9. The method according to claim 8, wherein the act of securing is performed using either at least one of: an adhesive, a thin absorbing film, a thin film of low melting glass, a glass frit and a direct glass bonding process.

10. The method according to claim 8, further comprising using at least one alignment fixture to align the canes on the upper surface of the glass support sheet prior to the act of securing the plurality of canes on the upper surface.

11. The method according to claim 8, wherein the at least one alignment fixture includes prongs each sized to closely fit into the second longitudinal bore, the prongs being spaced apart by a select distance that defines a center-to-center spacing of the alignment members on the glass support sheet.

12. The method according to claim 8, wherein the at least one alignment fixture includes spacing elements, with one spacing element being disposed between adjacent canes.

13. A method of forming an alignment member for a ferrule or a coupling apparatus, comprising:
forming a monolithic body with a central body axis, a length and a longitudinal central aperture in the form of a cross defined by first and second orthogonal sections having respective first and second central axes orthogonal to and that intersect at the central body axis, wherein the first and second orthogonal sections define four quadrants of the monolithic body, with each quadrant including a longitudinal bore that runs down the length of the monolithic body and offset from the central body axis;
separating the monolithic body into the four quadrants, with each quadrant defining an alignment sub-structure; and
cross-sectionally cutting at least one of the alignment sub-structures to form at least one alignment member.

14. The method according to claim 13, wherein the act of forming the monolithic body includes performing one of a molding process, a 3D printing process and an extrusion process.

15. The method according to claim 13, wherein each alignment sub-structure includes at least one recessed surface.

16. The method according to claim 13, wherein the at least one alignment member includes first and second alignment members, and further comprising attaching the first and second alignment members in a spaced apart configuration and using the respective recessed surfaces to either: i) a surface of a glass support substrate to form the ferrule or ii) a surface of a photonic integrated circuit to form the coupling apparatus.

17. The method according to claim 16, wherein the act of attaching is performed using an at least one of: an adhesive, a thin absorbing film, a thin film of low melting glass, a glass frit and a direct glass bonding process.

18. The method according to claim 13, wherein the monolithic body consists of a polymer.

19. The method according to claim 13, wherein the monolithic body has an outer cross-sectional shape that is substantially rectangular.

20. A method of forming an alignment member that can be used for both a ferrule assembly that has a glass support substrate that supports optical fibers and a coupling apparatus for a photonic integrated circuit (PIC) assembly having a PIC that supports optical waveguides, comprising:
drawing a glass preform to form a drawn glass preform section with a size reduction, wherein the glass preform has a longitudinal alignment feature and a rectangular cross-sectional shape with first and second adjacent sides;
dividing the drawn glass preform section into a plurality of alignment members, with each alignment member having a length L that is in the range from 2 millimeters to 20 millimeters; and
wherein the optical waveguides and optical fibers define a relative alignment offset Δz, and wherein the longitudinal alignment feature resides at a first distance H1 from the first side and a second distance H2 from the second side, wherein H1>H2 and wherein Δz is substantially equal to H1−H2.

21. The method according to claim 20, wherein the plurality of alignment members includes first, second, third and fourth alignment members, wherein the first and second adjacent sides have respective lengths w and h, where h>w, the method further comprising:
attaching the first and second alignment members in a spaced apart configuration to an upper surface of the glass support substrate of the ferrule assembly, with the respective first sides of the first and second alignment members facing the upper surface of the glass support substrate; and
attaching the third and fourth alignment members in a spaced apart configuration to an upper surface of the PIC of the PIC assembly, with the respective second sides of the third and fourth alignment members facing the upper surface of the PIC.
